(19) United States
(12) Patent Application Publication
(10) Pub. No.: US 2014/0087085 A1
(43) Pub. Date: Mar. 27, 2014

(54) METHOD AND DEVICE FOR COATING A FLOAT GLASS STRIP

(71) Applicant: Innovent e.V., Jena (DE)

(72) Inventors: Bernd GRUENLER, Zeulenroda (DE); Andreas HEFT, Gera (DE); Thomas STRUPPERT, Jena (DE); Paul RUEFFER, Jena (DE)

(73) Assignee: Innovent e.V., Jena (DE)

(21) Appl. No.: 14/094,246

(22) Filed: Dec. 2, 2013

Related U.S. Application Data
(63) Continuation of application No. PCT/EP2012/060170, filed on May 30, 2012.

(30) Foreign Application Priority Data
May 31, 2011 (DE) DE 102011076830.0

(51) Int. Cl. C03C 17/00

(52) U.S. Cl. CPC C03C 17/002
USPC 427/446; 118/723 R

(57) ABSTRACT

A method for coating a float glass strip following its production process, the float glass strip being transported out of a float glass bath by a conveyor device in which the float glass strip cools and/or is cooled, a coating occurring in at least two coating devices arranged successively along the conveyor device, a coating being performed by each of the coating devices at a location at which the temperature of the float glass strip is in a temperature range that is different from the temperature ranges of the float glass strip in the area of the other coating devices.

This nonprovisional application is a continuation of International Application No. PCT/EP2012/060170, which was filed on May 30, 2012, and which claims priority to German Patent Application No. DE 10 2011 076 830.0, which was filed in Germany on May 31, 2011, and which are both herein incorporated by reference.

### BACKGROUND OF THE INVENTION

1. Field of the Invention

The present invention relates to a method for coating a float glass strip and relates to a device for coating a float glass strip.

2. Description of the Background Art

To influence surface properties of various substrates, coating methods in which coating substances from a chemical vapor are deposited on a surface have been commonly used for some time. A distinction is made inter alia between chemical and physical chemical vapor deposition. In the chemical methods, so-called precursors of the coating substance are converted generally by means of adding energy, and reaction products of the precursors are guided onto the surface and deposited there. The energy may be added for instance by means of flame impingement. During its thermal conversion, the precursor supplied to the flame forms particles, especially nanoparticles, that agglomerate while still in the flame and then deposit on the surface. This makes it possible to have a homogeneous and dense coating, but the energy input is high. So-called low pressure plasma methods in which the precursor is converted in a plasma source or in its physical vicinity on the surfaces to be coated, creating thin films, offer another option. However, this method, which is advantageous in terms of energy, requires evacuated process chambers and is therefore complex and inflexible.

In the past few years so-called atmospheric pressure plasma methods have become known in which the surfaces to be coated do not have to be placed in a vacuum. The particles are formed in the plasma. The size of the agglomerates created and thus the essential properties of the coating may be adjusted inter alia using the distance between the plasma source and the surface. Provided the substrate is guided appropriately, the homogeneity of the deposited layers is comparable to the homogeneity of the layers deposited by flame impingement, but the energy input is significantly lower.

Refining glass surfaces by means of PVD (physical vapor deposition—physikalische Gasphasenabscheidung) has been known for quite some time. By bombarding atoms of one material with high-energy inert gas ions (sputter process), it is possible to break their bonds and deposit them on the substrate (flat glass panes approx. 3×6 m² in size).

The sputter method is often used for depositing layers. However, it also involves very complex and also expensive equipment, since low pressure and/or special atmospheres are required.

Methods are also known in which organometallic and/or inorganic metal compounds (precursors) are placed into a flame, decomposed by combustion process, and deposited on a surface. These methods are called CCVD methods (combustion chemical vapor deposition—verbrennungsbasierte chemische Gasphasenabscheidung) or flame pyrolysis methods. One such method for coating hot glass surfaces is disclosed in DE 10 2006 029 617 A1.

Known from DE 42 37 921 A1 is a method for modifying the surface activity, such as hydrophilization, of a silicate glass substrate by applying a silicon-containing coating using at least one organosilicon compound, the silicon-containing coating being applied as an SiOx coating using flame-pyrolytic decomposition of the organosilicon compound(s). A float glass strip may be coated in a production-hot condition. A number of linear burners are arranged successively along a transport device for the float glass strip downstream of a float gas bath. The float glass strip is coated on a bottom side of the float glass, which bottom side has passed through a tin bath. Due to its poor cross-linkability, it is hydrophilized with an SiOₓ layer comprising at least two individual layers by means of an apparatus integrated into the float glass production process.

### SUMMARY OF THE INVENTION

It is therefore an object of the present invention to provide an improved method and an improved device for coating a float glass strip.

In an embodiment for coating a float glass strip following its production process, the float glass strip is transported out of a float glass bath by a conveyor device in which the float glass strip cools and/or is cooled, a coating being performed in at least two groups of coating devices arranged successively along the conveyor device. Each of the groups includes at least one coating device. Using each of the groups, a coating is performed in one area of the float glass strip in which the temperature of the float glass strip is in a temperature range that is different from the temperature ranges of the float glass strip in the area of the other group or groups.

For example, the groups may each include one coating device or two or more coating devices.

The conveyor device for the float glass strip may have a considerable length, for instance 200 m. The float glass, which at first is still hot from production, generally cools or is actively cooled on this segment, for example by fans, from a temperature of about 650° C. generally to room temperature. The cooling occurs such that there is a drop in temperature in the float glass strip of just a few Kelvin per meter in order to prevent stresses in the float glass. The float glass therefore remains essentially in the same temperature range across long segments of several meters. Consequently, in accordance with the invention the groups of coating devices are arranged spaced several meters from one another in order to provide a coating in temperature ranges that are different from one another.

By integrating the inventive method and the inventive device in systems for producing float glass it is possible to attain savings in complex and expensive secondary processes for generating functional layers on flat glass surfaces. Integration into existing production lines is possible with no problem using the comparatively simple and cost-effective system structure of this coating process. Moreover, for forming the coating it is possible to make excellent use of the high substrate temperatures that the glass passes through during the production process.

Using the inventive coating by means of a plurality of coating devices it is possible to attain a desired coating thickness that it is not possible to attain by means of a single coating device at the relatively high advancing speed of the float glass strip. With coating by means of a large number of coating devices in the same temperature range, as is known from prior art, the float glass is reheated in one area by the relatively high energy input, and stresses are created in the float glass that could lead to inhomogeneities to the point of the float glass cracking. In contrast, in the inventive method the coating occurs in temperature ranges that are different from one another, the energy input from each of the individual groups of coating devices being so low that reheating is largely avoided so that hardly any stresses occur.

When there are a plurality of coating devices within a group, they may be spaced apart from one another such that their energy input into the float glass strip is so low that reheating is largely avoided so that hardly any stresses occur.

The transport device is generally designed as a closed tunnel into which cool air is blown. The coating devices may be arranged in tunnel windows through the course of the tunnel.

The inventive inline coating method is suitable for providing glass surfaces with functional layers. The coating may take place under normal pressure (also called atmospheric pressure). The layer or a plurality of layers may deposited on the glass surface using a flame or a plasma. The deposited layers may be used for instance as anti-corrosion and/or barrier layers.

A multilayer structure of the coating may be created by means of the inventive method.

The inventive method may be integrated into the float glass production process in order to modify the glass surface as desired. This is especially applicable for corrosion protection. It is known that the top side of the float glass, which does not come into contact with the tin bath (also called the atmosphere side) is far more chemically active in connection with water than the tin bath side. Corrosion of flat glass therefore occurs primarily on the atmosphere side. The layers applied by means of the inventive method are therefore in particular applied to the atmosphere side in order to reduce or completely prevent this corrosion on the flat glass surface. However, it is also possible to coat the tin bath side or both sides.

The deposited layers may advantageously be provided with additional properties, such as e.g. imparting adhesiveness or an anti-reflective effect.

For instance, at least one silicon oxide layer (SiOₓ) may be applied at least to the atmosphere side of the flat glass using a flame pyrolysis method (CCVD) by means of a flame burner. The deposition may be performed at atmospheric pressure and without protective gases.

When a flame burner is used as the coating device, a flame is produced in the flame burner from a combustion gas and at least one precursor is supplied to the combustion gas or flame, at least one reaction product of at least one of the precursors being deposited on a surface of the float glass strip.

Alternatively or in a different temperature range, a plasma source may be used in which a plasma is produced from a working gas and at least one a precursor is supplied to the working gas or to the plasma, at least one reaction product of at least one of the precursors being deposited on a surface of the float glass strip.

Deposition in different temperature ranges can cause the deposited layers or parts of the layer to have different properties. For instance, a layer deposited at a high temperature at which the glass is still plastic is particularly thin and dense and therefore has good barrier properties that prevent diffusion out of the glass and/or into the glass. In contrast, a layer deposited at a low temperature has greater roughness and is therefore suitable for a scattering layer to reduce reflection on the surface of the glass and to improve transmission of light through the glass.

Prior to the coating, the surface of the float glass strip may be activated with a plasma source or flame burner arranged in the course of the float glass strip upstream of the first coating device. The flame or the plasma is not doped.

Activation may also be performed in a temperature range that is different from the temperature ranges of each of the other coating devices.

In an embodiment of the method, the same precursor may be used in each of the coating devices and the same reaction product may be deposited. It is also possible to use different precursors in different coating devices and to deposit correspondingly different reaction products so that different layers with different properties are created.

In particular a silicon-containing precursor, for instance hexamethyl-disiloxane (HMDSO) or tetraethyl orthosilicate (TEOS), may be used so that a silicon oxide, in particular silicon dioxide or a modified silicon oxide, is deposited as a reaction product.

For instance, a first coating may performed at a temperature of 450° C. to 650° C., especially about 500° C., a second coating may be performed at a temperature of 200° C. to 450° C., especially 250° C. to 300° C., preferably about 250° C., and a third coating may be performed at a temperature of less than 200° C., preferably less than 160° C. A fourth coating may take place below this temperature, for instance at a temperature of about 20° C. Adjacent temperature ranges selected for the coatings may differ by 50° C., preferably by 100° C. or more.

The first coating process may take place immediately following a production process for the glass if the glass leaves the float bath while still hot. The adhesion of a layer applied in this manner is particularly good because a fresh glass surface is especially reactive. Glass surfaces absorb water, carbon dioxide, and other substances from the atmosphere relatively rapidly and therefore lose a substantial amount of their reactivity.

If a plasma source is used for coating instead of the flame burner, the effect of this is that, in contrast to a flame or its combustion gases, the plasma does not heat the glass surface as intensely and thus deformation, especially formation of waves, is avoided. In addition, the energy expenditure is much lower than for flame impingement so that costs are reduced. Compared to simply spraying a coating solution or depositing particles from a gas stream in which the energy required for the reaction for forming the layer is taken from the heat of the glass, and thus, together with convection, leads to the glass cooling more rapidly than desired, the plasma coating process both supplies reaction energy and does not additionally further heat the surface up.

In contrast to a flame impingement, with a plasma coating method it is possible to exclude air and water vapor and reaction products from them with no problem, for instance by making a suitable selection of the working gas. In this manner it is possible for instance to keep air and oxygen away from the layers to be formed and from the surface. The described method may also be used on a substrate that has already been provided with at least one layer.

The layer may be deposited at atmospheric pressure (also called normal pressure) both during flame impingement and during plasma treatment. Normal pressure plasma methods require significantly less technical complexity than low pressure or vacuum methods, since there is no need for a reaction chamber that must be evacuated. In the normal pressure plasma method, the particles form in the plasma stream. The size of the agglomerates of these particles and thus essential properties of the coating may be adjusted inter alia using the distance between the plasma source and the surface. The homogeneity of the deposited layers is comparable to the homogeneity of layers deposited by flame impingement. Alternatively, the method may also be performed at slightly reduced normal pressure.

The plasma may be produced in a free stream plasma source. In this method, a high-frequency discharge is ignited between two concentric electrodes, the hollow cathode plasma forming due to an applied gas stream being led as a plasma jet out of the electrode arrangement generally several centimeters into the open and to the surface to be coated. The precursor may be introduced into the work gas prior to excitation (direct plasma processing) or into the plasma that has already formed or its vicinity thereafter (remote plasma processing). Another option for producing the plasma is to make use of a dielectrically prevented discharge. The working gas that is acting as the dielectric, especially air, is conducted between two electrodes. The plasma is discharged between the electrodes, which are fed with high-frequency high voltage. Likewise, the glass substrate may itself be used as the dielectric in that the gas stream is conducted between a surface electrode and the flat glass substrate.

The precursor is preferably introduced to the flame, working gas, or plasma stream in a gaseous state. Liquid or solid, especially powder, precursors may also be used, but are preferably converted to the gaseous state or to an aerosol-like state, for instance by vaporization, prior to being introduced. The precursor may also initially be introduced into a carrier gas, carried along by it, and introduced with it into the flame, working gas, or plasma stream.

The throughput of the combustion gas, working gas, and/or precursor is preferably variable and controllable and/or regulatable. In particular the throughputs of combustion gas, working gas, and precursor may be controlled and/or regulated independently of one another. Thus, in addition to the distance between the coating device and the surface to be coated, another device is available for influencing the layer properties, such as for instance the layer thickness or the refractivity. Likewise, it is possible to create gradient layers in this manner. Suitable selection of these process parameters and the precursors used make it possible to deliberately change the following properties of the substrate, for instance: scratch resistance, self-healing capacity, barrier behavior, reflection behavior, transmission behavior, refractivity, transparency, light scattering, electrical conductivity, antibacterial behavior, friction, adhesion, hydrophilia, hydrophobia, oleophobia, surface tension, surface energy, anticorrosive effect, stain resistance, self-cleaning capacity, photocatalytic behavior, anti-stress behavior, wear behavior, chemical resistance, biocide behavior, biocompatible behavior, electrostatic behavior, electrochromic activity, photochromic activity, gasochromic activity.

The deposited layer may include at least one of the components silicon, silver, gold, copper, iron, nickel, cobalt, selenium, tin, aluminum, titanium, zinc, zirconium, tantalum, chromium, manganese, molybdenum, tungsten, bismuth, germanium, niobium, vanadium, gallium, indium, magnesium, calcium, strontium, barium, lithium, lanthanide, carbon, oxygen, nitrogen, sulfur, boron, phosphorus, fluorine, halogens, or hydrogen. In particular, the layers include oxidic or/and nitridic compounds of silicon, titanium, tin, aluminum, zinc, tungsten, and zirconium.

Preferably used as precursor is an organosilicon compound, for instance hexamethyldisiloxane, tetramethylsilane, tetramethoxysilane, tetraethoxysilane, various cyclosiloxanes (e.g. decamethylcyclopentasiloxane). Organotitanium compounds, especially titanium tetraisopropylate or titanium tetraisobutylate, may also be used.

In this manner it is possible to create barrier layers that reduce permeability for gases, ions, and water.

In an embodiment, a first layer with a barrier effect is deposited and then at least one additional layer is deposited as functional layer, preferably having one of the aforesaid properties, on a soda-lime-silica glass (standard float glass). The barrier layer for instance reduces the passage of water, carbon dioxide, and other substances from the atmosphere to the surface of the glass substrate. Migration, especially of sodium, out of the glass into the functional layer is also reduced, so that its activity is maintained. The functional layer may be applied to the still hot glass or already cooled glass by means of the same method or by means of a different coating method.

In an embodiment, a device for coating a float glass strip following its production process includes a conveyor device for transporting the float glass strip out of a float glass bath, at least two coating devices being provided arranged successively along the conveyor device, each of the coating devices being arranged at a location at which a temperature of the float glass strip is in the temperature range that is different from the temperature ranges of the other coating devices.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein the sole FIGURE depicts a device for coating a float glass strip following its production process, including a conveyor device for transporting the float glass strip, two coating devices being arranged successively along the conveyor device.

### DETAILED DESCRIPTION

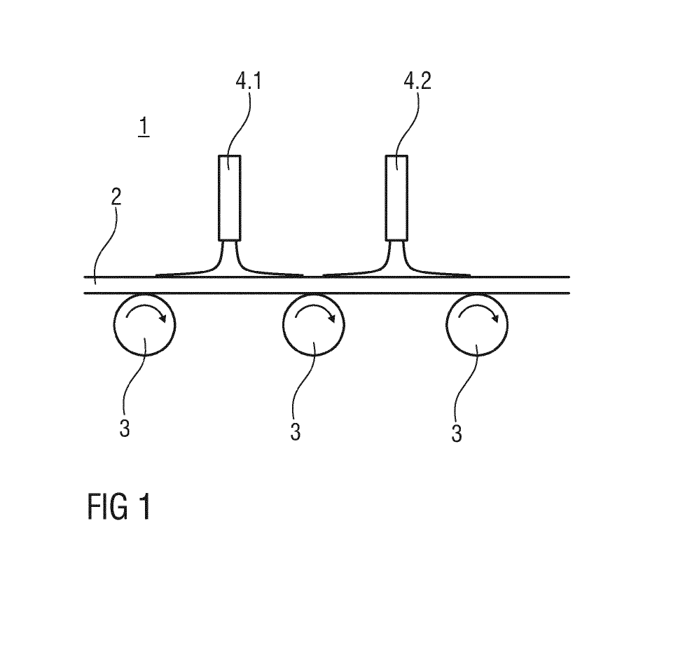

The FIG. 1 depicts a device 1 for coating a float glass strip 2 following its production process. The device 1 includes a conveyor device 3 for transporting the float glass strip 2. The conveyor device 3 includes a number of transport rollers on which the float glass strip 2 is transported. Two successively arranged coating devices 4.1, 4.2 are provided along the conveyor device 3.

The conveyor device 3 transports the float glass strip 2 from a float glass bath (not depicted), for instance by pulling the end of the float glass strip 2 that is removed from the float glass bath and at which the float glass strip 2 has already largely cooled. The float glass strip 2 may be passively or actively cooled by means of ventilation. Each coating device 4.1, 4.2 performs at coating process at a location at which the temperature of the float glass strip 2 is in a temperature range that is different from the temperature ranges of the other coating devices 4.2, 4.1.

For instance, a coating system comprising non-metal and/or metal oxides and/or mixtures thereof is deposited. In the example illustrated, the atmosphere side of the flat glass strip 2 is used as the substrate. The tin bath side or both sides may also be coated.

Instead of the individual coating devices 4.1, 4.2, groups of coating devices 4.1 to 4.n may be provided, coating being performed by each of the groups of coating devices 4.1, 4.2 in an area in which the temperature of the float glass strip 2 is in a temperature range that is different from the temperature ranges of the other groups of coating devices 4.2, 4.1.

### Example 1

### SiOₓ

A silicon oxide layer system (SiOₓ) is deposited. Deposition of this layer system on the float glass strip 2 may be used for corrosion protection, to promote adhesiveness, or as an anti-reflection layer. Organosilicon compounds, especially HMDSO and TEOS, may be used as precursors for the pyrolytic deposition of these layers.

### Example 2

### SiOₓ/Al₂O₃

A silicon oxide layer system (SiOₓ) doped with aluminum oxide (Al₂O₃) is deposited. This layer system acts primarily as a barrier layer. Organosilicon compounds with dissolved organoaluminum compounds, for instance aluminum acetylacetonate, may be used as precursors for the pyrolytic deposition of these layers.

### Example 3

### SiOₓ/P₂O₅

A silicon oxide layer system (SiOₓ) doped with phosphorus oxide (P₂O₅) is deposited. This layer system also acts primarily as a barrier layer. Organosilicon compounds with dissolved organophosphorus compounds, for instance, triethyl phosphate, may be used as precursors for the pyrolytic deposition of these layers.

The following parameters may be used for instance for the pyrolytic deposition in the above examples:

Gas mixture: Combustion gas mixture (propane/air)

Volume flow of air: 450 L/min to 600 L/min

Propane/air ratio: 1:15 to 1:25, preferably 1:20

Burners: 2 standard burners, 300-mm wide

Substrate temperature: 260° C., 160° C. and 20° C.

Substrate speed: 503 cm/min to 880 cm/min

Distance from substrate to burner: 20 mm to 30 mm

Number of burners: 2 per temperature range

Burner width: 300 mm

Precursors: SiOₓ HMDSO, TEOS
Al₂O₃ Aluminum acetylacetonate
PₓO_{y} Triethyl phosphate

At a wider burner width, greater volume flows of air are necessary, for instance 5000 L/min to 7000 L/min at a burner width of 3600 mm.

Propane, butane, methane, and natural gas may be used as the combustion gas, for instance. Air or oxygen is particularly suitable for an oxidizing agent. The temperature ranges in which the coating devices 4.1, 4.2 are arranged may have substrate temperatures of 20° C. to 650° C., for instance. The distance between the coating device 4.1, 4.2 and the float glass strip 2 may be for instance between 5 mm and 100 mm. A greater number of coating devices 4.1 to 4.n may be provided. A width of the coating device 4.1 to 4.n is selected for instance corresponding to a width of the float glass strip 2, for instance 3400 mm.

Instead of the flame burner, it is possible to use as a coating device a plasma source in which a plasma is produced from a working gas and at least one precursor is supplied to the working gas or the plasma, at least one reaction product of at least one of the precursors being deposited on a surface of the float glass strip.

The following parameters for instance may be used for a homogeneous and adhesive plasma coating using a free stream plasma torch comprising for instance 14 individual nozzles and having a 10-cm treatment range:

Number of passages: 6×10

Offset perpendicular to the sample direction

of transport: 0; 3.5; 7; 7; 3.5; 0 mm

Travel speed: 100 mm/sec

Distance between torches: 10 mm

Precursor: HMDSO

Precursor doping: 20 mL/min HMDSO gas

Plasma preactivated: Yes

Prior to coating, the surface of the float glass strip 2 may be activated with a plasma source or flame burner arranged in the course of the float glass strip 2 upstream of the first coating device 4.1.

This activation may be performed in a temperature range that is different from the temperature ranges of each of the coating devices 4.1 to 4.n.

The same precursor may be used in each of the coating devices and the same reaction product may be deposited. Likewise, it is possible to use different precursors in different coating devices 4.1 to 4.n and to deposit correspondingly different reaction products so that different layers with different properties result.

For instance, a first coating may be performed at a temperature of 450° C. to 650° C., especially about 500° C., a second coating may be performed at a temperature of 200° C. to 450° C., especially 250° C. to 300° C., preferably about 250° C., and a third coating may be performed at a temperature of less than 200° C., preferably less than 160° C. A fourth coating may follow below this temperature, for instance at a temperature of about 20° C. Adjacent temperature ranges selected for the coatings may differ by 50° C., preferably by 100° C. or more.

They layers may be deposited especially at atmospheric pressure.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for coating a float glass strip following its production process, the method comprising:
transporting the float glass strip out of a float glass bath by a conveyor device in which the float glass strip cools and/or is cooled;
coating, in at least two groups of coating devices arranged successively along the conveyor device, each of the groups of coating devices includes at least one coating device
using each of the groups, a coating is performed in one area of the float glass strip in which a temperature of the float glass strip is in a temperature range that is different from a temperature ranges of the float glass strip in an area of the other group or groups; and
selecting adjacent temperature ranges for the coating having a difference of 50° C. or more.

2. The method in accordance with claim 1, wherein a flame burner in which a flame is produced from a combustion gas and at least one precursor is supplied to the combustion gas or the flame is used for the coating device, and wherein at least one reaction product of at least one of the precursors is deposited on a surface of the float glass strip.

3. The method in accordance with claim 1, wherein a plasma source in which a plasma is produced from a working gas and at least one precursor is supplied to the working gas or the plasma is used for the coating device, and wherein at least one reaction product of at least one of the precursors is deposited on a surface of the float glass strip.

4. The method in accordance with claim 1, wherein, prior to the coating, the surface of the float glass strip is activated with a plasma source or flame burner arranged in a course of the float glass strip upstream of the first coating device.

5. The method in accordance with claim 4, wherein the activation is performed in a temperature range that is different from a temperature ranges of each of the other coating devices.

6. The method in accordance with claim 1, wherein in each of the coating devices the same precursor is used and the same reaction product is deposited.

7. The method in accordance with claim 1, wherein a silicon-containing precursor is used so that a silicon oxide, in particular silicon dioxide or a modified silicon oxide, is deposited as a reaction product.

8. The method in accordance with claim 1, wherein a first coating is performed at a temperature of 450° C. to 650° C., especially about 500° C., a second coating is performed at a temperature of 200° C. to 450° C., especially 250° C. to 300° C., preferably about 250° C., and a third coating is performed at a temperature of less than 200° C., preferably less than 160° C.

9. The method in accordance with claim 1, wherein the coating is performed at atmospheric pressure.

10. A device for coating a float glass strip following its production process,
a transport device adapted to transport the float glass strip out of a float glass bath; and
at least two groups of coating devices being arranged successively along the conveyor device, each of the two groups of coating devices including at least one coating device,
wherein each of the groups is arranged at a location at which the temperature of the float glass strip is in a temperature range that is different from temperature ranges of the float glass strip in an area of the other group or groups, and
wherein adjacent temperature ranges being selected for the coating having a difference of 50° C. or more.

11. The device in accordance with claim 10, wherein the coating device is a flame burner in which a flame is produced from a combustion gas, wherein at least one precursor is supplied to the combustion gas or flame, and wherein at least one reaction product of at least one of the precursors is deposited on a surface of the float glass strip via the flame burner.

12. The device in accordance with claim 10, wherein the coating device is a plasma source in which a plasma is produced from a working gas, wherein a precursor is supplied to the working gas or plasma, and wherein at least one reaction product of at least one of the precursors is deposited on a surface of the float glass strip via the plasma source.

13. The device in accordance with claim 10, wherein a plasma source or a flame burner for activating the surface of the float glass strip is arranged in the course of the float glass strip upstream of the first coating device.

14. The device in accordance with claim 13, wherein, for activation, the plasma source or flame burner is arranged at a location at which the temperature of the float glass strip is in a temperature range that is different from the temperature ranges of each of the coating devices.

15. The device in accordance with claim 10, wherein a first group of coating devices is arranged at a location at which the temperature of the float glass strip is in a temperature range of 450° C. to 650° C., especially about 500° C., a second group of coating devices being arranged at a location at which the temperature of the float glass strip is in a temperature range of 200° C. to 450° C., especially 250° C. to 300° C., preferably about 250° C., and a third group of coating devices being arranged at a location at which the temperature of the float glass strip is in a temperature range of less than 200° C., preferably less than 160° C.
